(19) United States
(12) Patent Application Publication
(10) Pub. No.: US 2014/0375695 A1
(43) Pub. Date: Dec. 25, 2014

(54) DISPLAY DRIVING APPARATUS

(71) Applicant: Novatek Microelectronics Corp., Hsinchu (TW)

(72) Inventors: Yu-Pin Chang, Hsinchu County (TW); Kai-I Dai, Taoyuan County (TW)

(73) Assignee: Novatek Microelectronics Corp., Hsinchu (TW)

(21) Appl. No.: 14/016,139

(22) Filed: Sep. 2, 2013

(30) Foreign Application Priority Data
Jun. 21, 2013 (TW) 102122214

(51) Int. Cl. G09G 5/10

(52) U.S. Cl. CPC G09G 5/10
USPC 345/690

(57) ABSTRACT

A display driving apparatus including a plurality of driving circuits and a controller is provided. The driving circuits include a main driving circuit and a plurality of slave driving circuits. The driving circuits respectively receive a plurality of partial data of a display data from the controller. The slave driving circuits and the main driving circuit respectively generate a plurality of slave luminance distribution data and a main luminance distribution data. The slave driving circuits transport the generated slave luminance distribution data to the main driving circuit, and the main driving circuit generates a luminance control signal according to the slave luminance distribution data and the main luminance distribution data.

### CROSS-REFERENCE TO RELATED APPLICATION

This application claims the priority benefit of Taiwan application serial no. 102122214, filed on Jun. 21, 2013. The entirety of the above-mentioned patent application is hereby incorporated by reference herein and made a part of this specification.

### BACKGROUND OF THE INVENTION

1. Field of the Invention

The invention relates to a display driving apparatus, and more particularly to a display driving apparatus capable of performing a content adaptive brightness control (CABC).

2. Description of Related Art

With advancement of electronic technologies, electronic products have become an important tool in daily lives. An important function of electronic products is to provide a high quality display frame for the electronic products.

In a display driving apparatus of conventional art, a luminance adjusting method so called a content adaptive brightness control (CABC) is proposed. In a display panel of conventional art which is large in size and high in resolution, a plurality of driving circuits are utilized to drive the display panel. And, in order to calculate an optimal display luminance for the display panel of conventional art, one among the driving circuits is selected and served as a main driving circuit. Based on technical requirements of the content adaptive brightness control, it is required for the display driving apparatus of conventional art to utilize the main driving circuit for receiving all display data of a frame that the display panel intends to display, and adjustment of the optimal display luminance may only be obtained by having the main driving circuit to calculate and analyze all of the display data.

With data volume of the display data for the main driving circuit to receive and process gets bigger as screen resolution increases, a great burden for the display driving apparatus in terms of transporting/processing the data may occur. As a result, a bottleneck for improving display quality may also be formed.

### SUMMARY OF THE INVENTION

The invention is directed to a display driving apparatus for reducing complexity of circuit while improving data processing speed.

The invention provides a display driving apparatus, including a plurality of driving circuits and a controller. The driving circuits are sequentially connected in series, and respectively configured to drive a plurality of display area on the display panel. The driving circuits include a main driving circuit and a plurality of slave driving circuits. The controller is coupled to the driving circuits, in which the driving circuits respectively receive a plurality of partial data of a display data from the controller. The slave driving circuits and the main driving circuit respectively generate a plurality of slave luminance distribution data and a main luminance distribution data. The slave driving circuits transport the generated slave luminance distribution data to the main driving circuit, and the main driving circuit generates a luminance control signal according to the slave luminance distribution data and the main luminance distribution data.

In an embodiment of the invention, the controller transports the display data to the driving circuits, and each of the driving circuits receives a selected partial data among the partial data, wherein the selected partial data corresponds to each of the display areas driven by each of the driving circuits.

In an embodiment of the invention, each of the driving circuits masks off the partial data among the partial data which are not selected, so as to receive the selected partial data.

In an embodiment of the invention, the controller divides the display data into the partial data corresponding to the display areas, and transports the partial data to the driving circuits corresponding to the display areas.

In an embodiment of the invention, among the driving circuits, a first stage slave driving circuit directly connects the main driving circuit and directly transports the slave luminance distribution data of the first stage slave driving circuit to the main driving circuit, and an i+1th stage slave driving circuit transports the slave luminance distribution data of the i+1th stage slave driving circuit to the main driving circuit sequentially through an i-th stage slave driving circuit to the first stage slave driving circuit, wherein i is a positive integer.

In an embodiment of the invention, data volumes of the partial data are identical.

In an embodiment of the invention, data volumes of the partial data are proportional to sizes of the display areas respectively corresponding to the partial data.

In an embodiment of the invention, the main driving circuit further includes transporting the luminance control signal to the slave driving circuits.

In an embodiment of the invention, among the driving circuits, the main driving circuit directly connects a first stage slave driving circuit and directly transports the luminance control signal to the first stage slave driving circuit. The main driving circuit transports the luminance control signal to an i+1th stage slave driving circuit sequentially through an i-th stage slave driving circuit to the first stage slave driving circuit, wherein i is a positive integer being greater than 1.

Based on above, the invention divides the display data into a plurality of partial data, and respectively transports each of the partial data to different driving circuits. Each of the driving circuits then respectively analyzes a luminance distribution for the received partial data, so as to respectively obtain the main luminance distribution data and the slave luminance distribution data. Each of the slave driving circuits then transports the generated slave luminance distribution data to the main driving circuit, so that the main driving circuit can generate a luminance control signal by calculating the main luminance distribution data and the slave luminance distribution data. As a result, data transmission, analysis and calculation of the display data can be partitioned respectively by the main driving circuit and the slave driving circuits, such that complexity of the main driving circuit and processing speed can both be effectively reduced, so as to reduce circuit costs of the main driving circuit. Also, the display driving apparatus may easily be applied for driving a display panel with higher resolution.

To make the above features and advantages of the disclosure more comprehensible, several embodiments accompanied with drawings are described in detail as follows.

### BRIEF DESCRIPTION OF THE DRAWINGS

FIG. 1 is a schematic diagram of a display driving apparatus 100 according to an embodiment of the invention.

FIG. 2 is a schematic diagram of a display driving apparatus 200 according to another embodiment of the invention.

FIG. 3 is a flowchart of the display driving apparatus according to embodiments of the invention.

### DESCRIPTION OF THE EMBODIMENTS

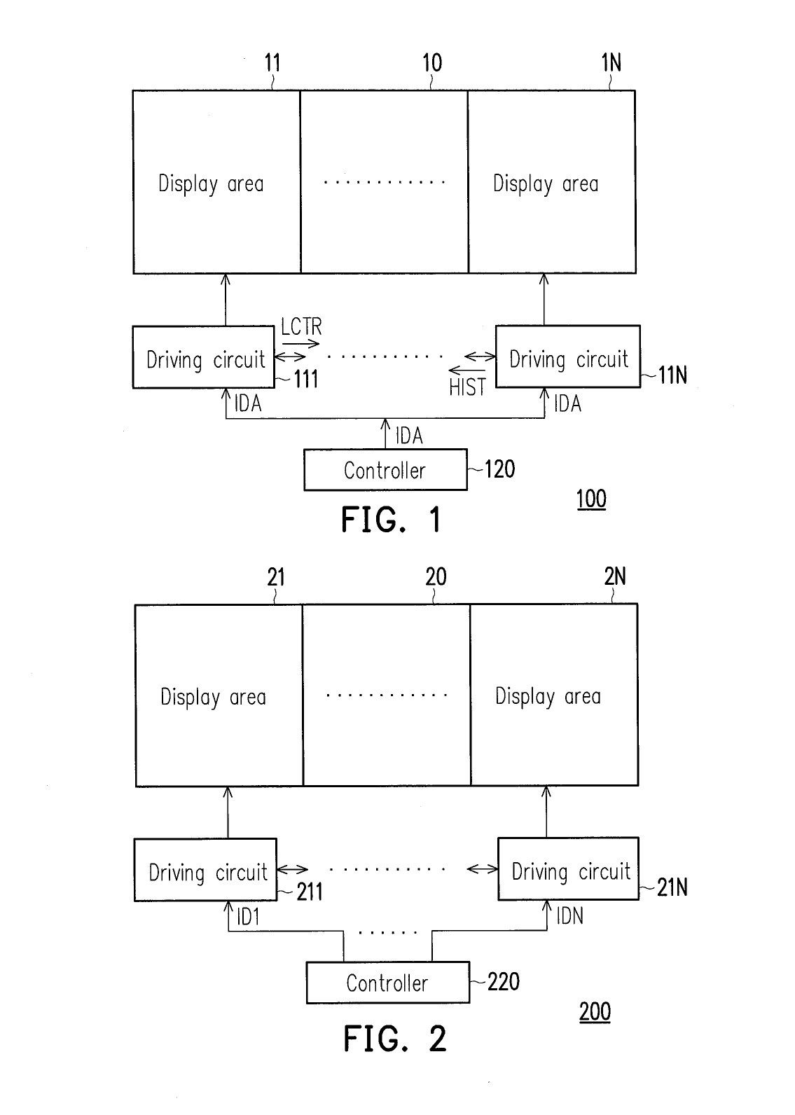

Referring to FIG. 1, FIG. 1 is a schematic diagram of a display driving apparatus 100 according to an embodiment of the invention. The display driving apparatus 100 includes a plurality of driving circuits 111 to 11N and a controller 120. The driving circuits 111 to 11N are coupled to a display panel 10 and configured to drive the display panel 10. Moreover, the display panel 10 includes a plurality of display areas 11 to 1N, in which the driving circuits 111 to 11N are respectively corresponding to the display areas 11 to 1N on the display panel 10, and the driving circuits 111 to 11N are respectively configured to drive the display panel 10, so that the display areas 11 to 1N can generate a display image.

The driving circuits 111 to 11N are connected in series, in which one among the driving circuits 111 to 11N can be set as a main driving circuit while the rest can be set as slave driving circuits. In the present embodiment, the driving circuit 111 can be set as the main driving circuit, and the rest of the driving circuits can be set as the slave driving circuits (such as the driving circuit 11N).

The controller 120 is coupled to the driving circuits 111 to 11N, and the controller 120 is configured to transport a display data IDA to the driving circuits 111 to 11N. Therein, the display data IDA is a data provided for the display panel 10 to display an entire frame. It should be noted that, each of the driving circuits 111 to 11N only receives one among a plurality of partial data in the display data IDA. In brief, the display data IDA can be divided into multiple data according to the corresponding display areas 11 to 1N, and the driving circuits 111 to 11N respectively can receive the plurality of partial data corresponding to the display areas 11 to 1N.

More specifically, take the driving circuit 111 as an example, when the driving circuit 111 intends to receive the corresponding partial data, the driving circuits 111 can mask off all of the partial data in the display data IDA which are corresponding to the display area 11, so as to receive a selected partial data corresponding to the display area 11 in the display data IDA. For the mask off operation as mentioned above, a mask circuit can be disposed on an input/output port of the driving circuit 111, and when the display data IDA transported by the controller 120 is the partial data corresponding to the display area 11, said mask circuit can permit the selected partial data to be transported to the driving circuit 111 through the input/output port. And, when the display data IDA transported by the controller 120 is not the partial data corresponding to the display area 11, said mask circuit can mask off a path for the partial data to be transported to the driving circuit 11 through the input/output port.

In addition, a transmission interface can be shared between the driving circuits 111 to 11N and the controller 120. In other words, all of the driving circuits 111 to 11N and the controller 120 perform a transmission of the display data IDA through the same data transmission line.

On the other hand, after the driving circuits 111 to 11N have received the partial data corresponding to the display areas 11 to 1N, a luminance distribution data of the partial data in each of the display areas 11 to 1N is then calculated. Among which, a main luminance distribution data is calculated and obtained from the driving circuit 111 being the main driving circuit, and slave luminance distribution data are calculated and obtained from the rest of the driving circuits being the slave driving circuits (i.e., all of the driving circuits besides the driving circuit 111). More specifically, the main luminance distribution data is an amount of pixels corresponding to different gray level values in the partial data corresponding to the display area 11. The slave luminance distribution data are amounts of pixels corresponding to different gray level values in the partial data not corresponding the display area 11. And, the main luminance distribution data and the slave luminance distribution data can also be represented in a histogram.

After calculation for the main luminance distribution data and the slave luminance distribution data are completed, the slave driving circuit (take the driving circuit 11N for instance) transports a slave luminance distribution data HIST being calculated by itself, to the main driving circuit (the driving circuit 111). The slave luminance distribution data HIST is transported stage by stage from the slave driving circuits sequentially connected in series, back to the driving circuit 111. For instance, an i+th stage slave driving circuit transports the slave luminance distribution data of the i+1th stage slave driving circuit to the main driving circuit sequentially through an i-th stage slave driving circuit to the first stage slave driving circuit, wherein i is a positive integer.

It should be noted that, the slave luminance distribution data can be synchronously transported from all of the slave driving circuit back to the main driving circuit, thus within same data transmission period, the data volume of the slave luminance distribution data transported by each of the slave driving circuits can be fixed. Above-said data transmission operation can be completed by utilizing a shift register such as a digital circuit, and a related description is omitted herein.

After all of the slave luminance distribution data are transported to the main driving circuit (the driving circuit 111), the driving circuit 111 can perform an integrated analysis according to all of the slave luminance distribution data which has been analyzed and the main luminance distribution data generated by the driving circuit 111, so as to generate a luminance control signal LCTR. The driving circuit 111 can also sequentially transport the luminance control signal LCTR to each of the slave driving circuits (e.g., the driving circuit 11N). As a result, all of the driving circuits 111 to 11N can, according to the luminance control signal LCTR, respectively adjust backlights of the display areas 11 to 1N and luminescences on the display area 11 to 1N where the partial data corresponding to the display areas 11 to 1N are addressed to.

For a transmission of the luminance control signal LCTR, the main driving circuit (the driving circuit 111) directly connects a first stage slave driving circuit and directly transports the luminance control signal LCTR to the first stage slave driving circuit, and the driving circuit 111 transports the luminance control signal LCTR to an i+1th stage slave driving circuit sequentially through an i-th stage slave driving circuit to the first stage slave driving circuit, wherein i is a positive integer being greater than 1.

Referring to FIG. 2, FIG. 2 is a schematic diagram of a display driving apparatus 200 according to another embodiment of the invention. The display driving apparatus 200 includes a plurality of driving circuits 211 to 21N and a controller 220. The driving circuits 211 to 21N are coupled to a display panel 20 and configured to drive the display panel 20. Moreover, the display panel 20 includes a plurality of display areas 21 to 2N, in which the driving circuits 211 to 21N are respectively corresponding to the display areas 21 to 2N on the display panel 20, and the driving circuits 211 to 21N are respectively configured to drive the display panel 20, so that the display areas 21 to 2N can generate a display image.

A difference between the present embodiment and the embodiment of FIG. 1 is that, different transmission interfaces are used to transmit a plurality of partial data ID1 to IDN between the controller 220 and the driving circuits 211 to 21N of the present embodiment. More specifically, the controller 220 respectively transports the partial data ID1 to IDN to the driving circuits 211 to 21N through a plurality of independent transmission interfaces. Accordingly, the driving circuits 211 to 21N may directly receive the partial data ID1 to IDN transported by the controller 220 without using the mask circuit.

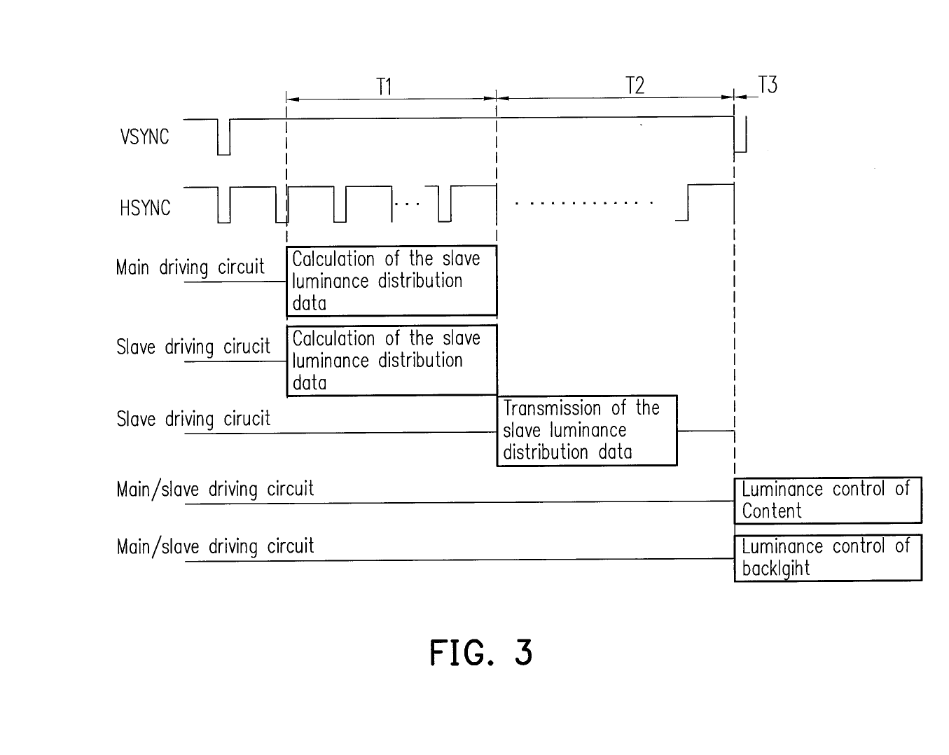

Referring to FIG. 3, FIG. 3 is a flowchart of the display driving apparatus according to embodiments of the invention. Therein, a process depicted in FIG. 3 is performed according to a vertical synchronizing signal VSYNC and a horizontal synchronizing signal HSYNC. In the same frame period, the main driving circuit and the slave driving circuits complete receiving of the partial data before a time period T1, and the main driving circuit and the slave driving circuits respectively calculate the main luminance distribution data and the slave luminance distribution data during the time period T1. In a time period T2 which is after the time period T1, the slave driving circuits sequential transport the slave luminance distribution data to the main driving circuit by using a shifting method. In a remaining time of the time period T2 after all of the slave luminance distribution data are transported to the main driving circuit, the main driving circuit can perform an integrated analysis for the slave luminance distribution data and the main luminance distribution data, so as to generate the luminance control signal. The main driving circuit then sequentially transports the luminance control signal to each of the slave driving circuits. In the next frame period, the main driving circuit and the slave driving circuits respectively perform a luminance control of content and a luminance control of backlight according to the luminance control signal.

In summary, the invention utilize the main driving circuit and the plurality of slave driving circuits to respectively receive the plurality of partial data divided according to the display data. The main driving circuit and the slave driving circuits then respectively analyze a luminance distribution for the received partial data, so as to respectively obtain the main luminance distribution data and the slave luminance distribution data. Accordingly, the main driving circuit only need to perform an integrated analysis for the main luminance distribution data and the slave luminance distribution data, such that the luminance control signal may be obtained to perform adjusting operations to the pixels and backlights in the display areas. As a result, the technical requirements of the content adaptive brightness control can be effectively and simply accomplished.

What is claimed is:

1. A display driving apparatus for driving a display panel, comprising:
a plurality of driving circuits sequentially connected in series, respectively driving a plurality of display areas on the display panel, and comprising a main driving circuit and a plurality of slave driving circuits; and
a controller coupled to the driving circuits,
wherein the driving circuits respectively receiving a plurality of partial data of a display data, the slave driving circuits and the main driving circuit respectively generating a plurality of slave luminance distribution data and a main luminance distribution data respectively according to the received partial data, the slave driving circuits transporting the generated slave luminance distribution data to the main driving circuit, and the main driving circuit generating a luminance control signal according to the slave luminance distribution data and the main luminance distribution data.

2. The display driving apparatus of claim 1, wherein the controller transports the display data to the driving circuits, and each of the driving circuits receives a selected partial data among the partial data, wherein the selected partial data corresponds to each of the display areas driven by each of the driving circuits.

3. The display driving apparatus of claim 2, wherein each of the driving circuits masks off the partial data among the partial data which are not selected, so as to receive the selected partial data.

4. The display driving apparatus of claim 1, wherein the controller divides the display data into the partial data corresponding to the display areas, and transports the partial data to the driving circuits corresponding to the display areas.

5. The display driving apparatus of claim 1, wherein among the driving circuits, a first stage slave driving circuit directly connects the main driving circuit and directly transports the slave luminance distribution data of the first stage slave driving circuit to the main driving circuit, and an (i+1)th stage slave driving circuit transports the slave luminance distribution data of the (i+1)th stage slave driving circuit to the main driving circuit sequentially through an i-th stage slave driving circuit to the first stage slave driving circuit, wherein i is a positive integer.

6. The display driving apparatus of claim 1, wherein data volumes of the partial data are identical.

7. The display driving apparatus of claim 1, wherein data volumes of the partial data are proportional to sizes of the display areas respectively corresponding to the partial data.

8. The display driving apparatus of claim 1, wherein the main driving circuit further comprises transporting the luminance control signal to the slave driving circuits.

9. The display driving apparatus of claim 1, wherein among the driving circuits, the main driving circuit directly connects a first stage slave driving circuit and directly transports the luminance control signal to the first stage slave driving circuit, and the main driving circuit transports the luminance control signal to an (i+1)th stage slave driving circuit sequentially through an i-th stage slave driving circuit to the first stage slave driving circuit, wherein i is a positive integer being greater than 1.
